(19) United States
(12) Patent Application Publication
(10) Pub. No.: US 2026/0285012 A1
(43) Pub. Date: Sep. 24, 2026

(54) METHOD AND SYSTEM FOR MANUFACTURING A COATED LAMINATED GLASS PANEL

(71) Applicant: AURYS INDUSTRIES, Carentan-les-Marais (FR)

(72) Inventors: Samir BOU OBEID, Gouvieux (FR); Franck MOLLARD, Bayeux (FR)

(73) Assignee: AURYS INDUSTRIES, Carentan-les-Marais (FR)

(21) Appl. No.: 19/163,418

(22) PCT Filed: Mar. 7, 2024
(86) PCT No.: PCT/EP2024/056113

§ 371 Date: Sep. 9, 2025

(30) Foreign Application Priority Data
Mar. 10, 2023 (FR) FR2302238
May 29, 2023 (FR) FR2305312
Jul. 21, 2023 (FR) FR2307834

(51) Int. Cl. B32B 17/10

(52) U.S. Cl. CPC B32B 17/10036; B32B 17/10091; B32B 17/10247; B32B 17/10651; B32B 17/10761; B32B 17/1077; B32B 17/10788; B32B 17/1099; B32B 2307/41; B32B 2307/416

(57) ABSTRACT

A method for manufacturing a coated laminated glass panel comprises: —providing a laminated glass panel to be coated, which comprises two glass sheets (11a, 11b) joined by means of a polymeric interlayer material (12); —providing a flowable decorative material; — forming a decorative coating layer (13) by applying the decorative material to the top face (11a1) of the laminated glass panel to be coated; —drying the decorative coating layer (13) by heating by means of a drying device, of which a setpoint temperature at the level of the polymeric interlayer material (12) is greater than or equal to 60° C. and less than 100° C., the drying device (112) comprising a laser heating device (108) suitable for emitting a beam in the direction of the decorative coating layer (13).

### FIELD OF THE INVENTION

The present invention relates to a method and system for manufacturing a laminated glass panel coated with a decorative layer.

More specifically, the invention relates to a method of manufacturing a laminated glass panel coated with a decorative layer such as a reflective layer or a lacquer.

### TECHNOLOGICAL BACKGROUND

In the field of decorative coated glass, two types of decorative layers are particularly popular: light-reflecting layers so that the glass has a mirror-like appearance, and “lacquer” type decorative layers, formed from a resin-rich paint and presenting a so-called stretched appearance.

Thus, a mirror classically consists of a monolithic glass with a thickness typically between 2 and 8 mm covered with a layer of silver which gives it its reflective power.

The thickness of the silver layer is typically of the order of a few tens of nanometers and its surface mass is generally at least 700 mg/m².

To improve the chemical and mechanical resistance of the silver layer, it can be covered with a protective varnish, most often with a thickness of around several micrometers.

Lacquered glass, on the other hand, typically consists of monolithic glass, typically between 2 and 12 mm thick, covered with a layer of decorative paint of the “lacquer” type—most often with a thickness of around several micrometers—which gives it the desired aesthetic appearance and which has satisfactory chemical and mechanical resistance characteristics.

These processes for coating monolithic glass, although aesthetically satisfactory, do not provide sufficient mechanical resistance properties for certain applications, particularly in the construction sector.

The safety of coated monolithic glass obtained by conventional processes can be improved by means of an anti-shatter adhesive film placed on the back of the glass, which retains the pieces of glass in the event of breakage, the mechanical performance of such a structure remaining limited since the risk of breakage is not or is only slightly modified by the presence of the anti-shatter film.

In the field of glass, it is also known to temper glass to improve its mechanical properties. Tempered glass cannot be re-cut after tempering. If we were to consider a decorative coating of tempered glass, we would therefore be limited by the shape of the piece of tempered glass before coating. We understand that this choice is very limiting for applications in the construction sector such as cupboard doors, tables, wall surfaces, which are often custom-made.

In the field of glass, it is also known to laminate glass to improve its mechanical properties. Laminated glass is an assembly of glass sheets and plastic interlayers, particularly in the form of FDM, generally made of polyvinyl butyral (PVB) or ethylene vinyl acetate (EVA). The presence of the interlayer material increases mechanical resistance to breakage and prevents the formation of splinters.

Various processes have been described which make it possible to obtain laminated glass mirrors or lacquered laminated glass, the decorative layer being interposed, or equivalently sandwiched, between two sheets of glass.

In particular, document GB2248160 describes a method for obtaining a laminated glass mirror in which: a reflective coating is deposited on a first sheet of glass, then a second sheet of glass is glued to the first sheet using an adhesive such as polyvinyl butyral (PVB), the reflective coating being interposed between the two sheets of glass.

Based on such a process, it is not possible to simply reverse the order of the components to position the reflective coating on an external face of the final product. Indeed, on the one hand the reflective coating (or any other decorative coating) thus positioned would then be mechanically damaged by the calendering or transport rollers used for assembling the two sheets, and on the other hand the autoclaving phase on an industrial scale presents a risk of deterioration of the coatings of the layers of a given panel and of sticking of the glass panels to each other.

In addition, the optical defects of the mirror formed by the method of GB2248160 are determined by those of the glass layer on which the reflective coating is deposited.

Similarly, WO2009/081077 describes a lacquered laminated glass in which a layer of lacquer is sandwiched between two sheets of glass, the assembly being subjected to heat treatment under pressure to ensure the bond between the sheets of glass. Such a process requires the use of a lacquer that is resistant to heat treatment under pressure, which limits the choice of colors. In addition, good adhesion of PVB can be affected, particularly when it comes to varnishes with aqueous solvents. Which presents future risks of product delamination.

Document FR 3 106 526 describes a method for manufacturing a coated laminated glass panel. After application, the lacquer is baked and dried by raising the room temperature to 120° C. in 6 minutes maximum, then lowered to room temperature in less than two minutes.

The invention thus aims to propose a method for coating a laminated glass panel with a decorative layer making it possible to obtain a coated laminated glass panel in an energy-efficient manner and having impact and/or perforation resistance and chip retention properties at least as good as those obtained by the methods of the prior art and improved optical and decorative properties compared to the methods of the prior art.

### SUMMARY OF THE INVENTION

Thus, the invention relates to a method of manufacturing a coated laminated glass panel comprising:
a laminated glass panel to be coated is provided comprising at least two sheets of glass and in which at least two successive sheets of glass are assembled by means of a polymer interlayer material forming, after assembly, an interlayer, the laminated glass panel to be coated having at least one upper face to be coated;
a flowing decorative material is provided;
at least one layer of decorative coating is formed by applying the decorative material in a fluid state to the upper face of the laminated glass panel to be coated;
the layer of decorative coating is dried by heating the laminated glass panel thus covered using a drying device whose set temperature at the level of the polymer interlayer material is greater than or equal to 60° C. and less than 100° C., the drying device comprising at least one LASER heating device adapted to emit a beam in the direction of the layer of decorative coating.

Thanks to these provisions, it is possible to industrially manufacture coated laminated glass panels without bubbling or yellowing of the interlayer material from already assembled laminated glass panels. In addition, the energy requirement is reduced by the implementation of localized LASER heating.

The coating process also makes it possible to manufacture a mirror-type glass panel and a lacquered glass panel with a reduced carbon footprint over the lifetime of the product. In fact, laminated glass is around five times stronger and around one hundred times more rigid than monolithic glass. It can therefore be expected that the renewal of mirrors/glasses lacquered in laminated glass will be less frequent than that of mirrors/glasses lacquered in the prior art.

According to one embodiment of the method for manufacturing a coated laminated glass panel, the polymer interlayer material is chosen from polyvinyl butyral, ethylene vinyl acetate, an ionoplast polymer, thermoplastic polyurethane and a casting resin.

These different polymer interlayer materials have different characteristics in terms of refractive index, mechanical resistance and hydrophobicity, which makes it possible to modulate the optical and/or mechanical properties and/or humidity resistance of the coated laminated glass panel depending on its future use.

According to one embodiment of the method for coating a laminated glass panel, at least one layer of decorative coating consists of either a layer of reflective material and one or more layers of protective varnish or one or more layers of lacquer and optionally one or more layers of protective varnish.

This arrangement makes it possible, using the same generic process, to form mirror-type laminated glass panels and colored laminated glass panels using a lacquer, these two types of laminated glass panels not having the same uses.

According to one embodiment of the method for coating a laminated glass panel, a chemical hardener or a crosslinking catalyst is incorporated into the fluid decorative material with a ratio P_cata between the mass of chemical hardener or crosslinking catalyst and the mass of decorative material in the determined fluid state; the ratio P_cata of the mass of chemical hardener or crosslinking catalyst with respect to the mass of decorative material in the fluid state is greater than 0.1%.

Such a proportion of chemical hardener makes it possible to limit the maximum surface temperature reached by the glass panel, so that the interlayer polymer material does not bubble or yellow and that the crosslinking of the layer of decorative coating is satisfactory with a drying time at this maximum surface temperature which is limited and particularly acceptable in an industrial process.

According to one embodiment of the method for coating a laminated glass panel, the chemical hardener or the crosslinking catalyst is chosen from acid catalysts and optionally from hydrofluoric acid, phosphoric acid and paratoluenesulfonic acid.

These chemical hardeners and crosslinking catalysts have the advantage of allowing the crosslinking temperature to be lowered sufficiently to avoid bubbling problems.

According to one embodiment, the drying device further comprises at least one heating device adapted to carry out convective and radiative heating.

According to one embodiment, a conveyor system moves the coated laminated glass panel in the drying device between an inlet and an outlet defining a length of the furnace, and the LASER heating device is adapted to emit the beam towards a beam interception location with the layer of decorative coating offset from the inlet by at least one tenth, in particular at least one fifth, of the length of the furnace.

According to one embodiment, said heating device adapted to carry out convective and radiative heating is arranged upstream of the LASER heating device.

According to one embodiment, said set temperature (Tint) is less than 80° C.

According to one embodiment, the heating system is configured to generate at the level of the layer of decorative coating a surface energy of between 400 and 1500 kJ/m² of panel, in particular between 450 and 850 kJ/m², in particular between 500 and 800 kJ/m², between 550 and 750 kJ/m², or even between 600 and 700 kJ/m².

This range allows to exceed, at the level of the layer of decorative coating, an average temperature threshold allowing the crosslinking of the layer of decorative coating, without burning effect and without adverse effect on the underlying layer of polymer interlayer material.

According to one embodiment, an emitter of the LASER heating device emits a LASER beam at a power of less than 100 W, in particular less than 50 W, less than 40 W, less than 35 W, or even less than 30 W.

This power range can achieve the desired heating effect, without burning, for limited energy consumption.

According to one embodiment, the LASER heating device is configured to have an inter-line gap of between 10 microns and 100 microns, in particular between 25 and 85 microns, or even between 35 and 75 microns.

This range of inter-line spacing can provide heat in a sufficiently homogeneous manner at the level of the layer of decorative coating.

According to one embodiment, the LASER heating device is configured to have a defocusing at the level of the layer of decorative coating of between 5 mm and 50 mm, in particular between 10 mm and 40 mm, or even between 15 mm and 30 mm.

This defocusing range allows the heat to be distributed sufficiently evenly across the layer of decorative coating.

According to one embodiment, the LASER heating device is configured to move the LASER beam at the level of the layer of decorative coating at a speed of between 0.2 m/s and 10 m/s, in particular between 1 m/s and 5 m/s, or even between 2 m/s and 3 m/s.

This speed range allows the heat to be distributed sufficiently evenly across the layer of decorative coating.

According to one embodiment, the LASER heating device is configured to generate a number of passages of the LASER beam at each point of the layer of decorative coating of between 1 and 200, in particular between 2 and 50, between 5 and 20, or even between 10 and 15.

This range of passage numbers allows the local temperature level to be maintained above a threshold value for a time greater than a predetermined threshold duration.

According to one embodiment, the LASER heating device comprises a plurality of LASER diodes, in particular between 100 and 2000 LASER diodes.

According to one embodiment, a laminated glass panel to be coated is provided comprising at least one layer of silver having said upper face to be coated.

According to one embodiment, said LASER heating device is adapted to emit said beam in the near infrared towards the layer of decorative coating.

This is because the glass panel is transparent to such radiation, which helps reduce the heating of the glass panel itself.

According to another aspect, the invention relates to a system for manufacturing a coated laminated glass panel comprising:
a laminated glass panel to be coated comprising at least two sheets of glass and in which at least two successive sheets of glass are assembled by means of a polymer interlayer material forming after assembly an interlayer, the laminated glass panel to be coated having at least one upper face to be coated;
a fluid decorative material;
an application device adapted to apply decorative material in a fluid state to the upper face of the laminated glass panel to be coated to form at least one layer of decorative coating;
a drying device adapted to dry the layer of decorative coating by heating the laminated glass panel thus covered with a set temperature at the level of the polymer interlayer material greater than or equal to 60° C. and less than 100° C., the drying device comprising at least one LASER heating device adapted to emit a beam in the direction of the layer of decorative coating.

According to one embodiment, the heating system is configured to generate at the level of the layer of decorative coating a surface energy of between 400 and 1500 kJ/m² of panel, in particular between 450 and 850 kJ/m², in particular between 500 and 800 kJ/m², between 550 and 750 kJ/m², or even between 600 and 700 kJ/m².

According to one embodiment, an emitter of the LASER heating device is adapted to emit a LASER beam at a power of less than 100 W, in particular less than 50 W, less than 40 W, less than 35 W, or even less than 30 W.

This power range can achieve the desired heating effect, without burning, for limited energy consumption.

According to one embodiment, the LASER heating device is configured to have an inter-line gap of between 10 microns and 100 microns, in particular between 25 and 85 microns, or even between 35 and 75 microns.

According to one embodiment, the LASER heating device is configured to have a defocusing at the level of the layer of decorative coating of between 5 mm and 50 mm, in particular between 10 mm and 40 mm, or even between 15 mm and 30 mm.

According to one embodiment, the LASER heating device is configured to move the LASER beam at the level of the layer of decorative coating at a speed of between 0.2 m/s and 10 m/s, in particular between 1 m/s and 5 m/s, or even between 2 m/s and 3 m/s.

According to one embodiment, the LASER heating device is configured to generate a number of passages of the LASER beam at each point of the layer of decorative coating of between 1 and 200, in particular between 2 and 50, between 5 and 20, or even between 10 and 15.

According to one embodiment, the LASER heating device comprises a plurality of LASER diodes, in particular between 100 and 2000 LASER diodes.

According to one embodiment, said LASER heating device is adapted to emit said beam in the near infrared towards the layer of decorative coating.

### BRIEF DESCRIPTION OF THE DRAWINGS

Embodiments of the invention will be described below with reference to the drawings, briefly described below:

FIG. 1 represents a side view of a laminated glass panel coated according to the invention.

FIG. 2 is a schematic side sectional view of an installation according to a first embodiment.

### DETAILED DESCRIPTION

The laminated glass panel to be coated comprises at least two glass sheets, among which an upper glass sheet 11a and a lower glass sheet 11b are defined. The terms “lower” and “upper” are used when referring to the orientation of the panel in the furnace, regardless of the previous or subsequent orientation of the panel.

Any type of flat glass (or possibly curved by bending processes known to those skilled in the art, when it comes to coating curved surfaces) can be used for each of the glass sheets.

Each sheet of glass is by definition monolithic.

In one embodiment, one or more of the at least two glass sheets are produced by the float process to obtain a flat and smooth glass sheet with very good precision, or by drawing or rolling processes.

In one embodiment, at least one or all of the glass sheets are tempered.

In one embodiment, the upper glass sheet 11a, one face of which will ultimately be coated with at least one layer of decorative coating 13 at the end of the method according to the invention, is not made of tempered glass. Tempered glass can indeed present micro-deformations likely to alter the decorative qualities of the coating, particularly in the case where this coating is obtained or contains a layer obtained by a silvering process.

In the case where none of the glass sheets are tempered, the laminated glass panel has the advantage of being able to be re-cut to the desired dimensions and/or for downgrading the edges if their characteristics are not satisfactory at the end of the process.

There are no limitations on the dimensions of the at least two sheets of glass, apart from those linked to the manufacturing process of each of the sheets of glass and the assembly process. In particular, the thickness of a glass sheet can be between 2 and 12 mm, or even more, depending on the final use of the coated laminated glass panel. For example, a thickness of 2 mm to 6 mm, or even 2 mm to 5 mm or 2 mm to 4 mm or even 2 mm to 3 mm, and in particular equal to 2 mm, 3 mm, 4 mm, 5 mm or 6 mm, for one or more of the at least two sheets of glass may be considered.

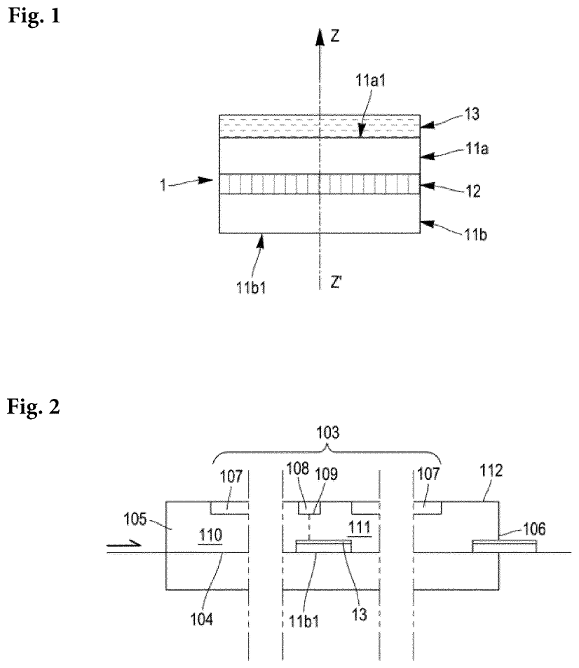

The at least two sheets of glass may have identical or different thicknesses and/or compositions two by two. The at least two sheets of glass are superimposed on each other in a stacking direction (Z′Z) and assembled two by two by means of at least one polymer interlayer material, so that after assembly, at least one interlayer 12 is inserted (or equivalently sandwiched) between at least two successive sheets of glass, as shown in FIG. 1.

Regardless of the number of superimposed glass sheets (two or more), the laminated glass panel to be coated therefore comprises at least:
an upper glass sheet 11a whose face external to the assembly is intended to receive the coating and constitutes the so-called upper face 11a1 of the laminated glass panel to be coated,
and a lower glass sheet 11b consisting of the glass sheet furthest from the upper glass sheet 11a in the stacking direction (Z′Z) and whose face external to the assembly constitutes the lower face 11b1 of the laminated glass panel to be coated.

The polymeric interlayer material may comprise one or more polymers.

In particular, the polymeric interlayer material may be polyvinyl butyral (PVB). PVB offers the following advantages, among others:
PVB has a refractive index close to that of soda-lime-silica glass commonly used for making glazing, so that the interlayer sheet is invisible or almost invisible.
PVB also absorbs shocks very effectively and retains glass fragments in the event of breakage.

It may also be ethylene vinyl acetate (EVA). The hydrophobic properties of EVA are particularly interesting if the coated glass panel is intended to be installed in a humid environment or outdoors: the risk of delamination over time due to humidity is reduced by the use of EVA for the interlayer 12 of polymer material.

It is also possible to use a polymer interlayer material called “ionoplast”, in particular of the SentryGlass® type, which allows the formation of laminated glass which does not present any bubbling or yellowing defects even when exposed during their installation to high temperatures, up to 80° C.

In another embodiment, the interlayer material may still be thermoplastic polyurethane (also called TPU or “Thermoplastic PolyUrethan”) or a casting resin (or equivalently “CIP” (“Cast In Place”) resin).

The interlayer material can be tinted before assembly, so as to give a particular coloring to the laminated glass panel in association with the decorative coating once the panel is coated. Once the laminated glass panel to be coated is supplied, a decorative material is provided in a fluid state.

The decorative material in the fluid state may in particular be in the liquid state with a more or less significant viscosity, this viscosity being adapted to allow the deposition of a layer of decorative material on the laminated glass panel, for example by means of a roller or a spray gun or even a curtain machine.

The decorative material can be lacquer.

A lacquer is a non-transparent coating, which can be translucent, but which is generally opaque, and which comprises, before drying, a solvent in which at least one pigment and at least one polymeric resin are dissolved, as well as optionally mineral fillers.

The function of pigments is to provide the desired color and opacity.

The polymer resin acts as a binder: it is used to bind the pigments and, where applicable, the mineral fillers after drying.

The binder is preferably acrylic resin based. The binder can also be based on alkyd resin or a polyurethane binder.

For example, the decorative material can be a lacquer such as Glassolux (produced by Fenzi®) or equivalent.

The lacquer can be applied, for example, using a curtain machine, a roller or a gun in one or more passes.

The choice of the number of passes for depositing the lacquer, and consequently the number of layers of lacquer, can be determined in particular according to the desired opacity and/or the desired mechanical resistance.

The thickness of the lacquer deposited can be between 10 and 100 micrometers.

The decorative material can also be a reflective material after drying.

The laminated glass panel may, for example, comprise a decorative material, for example comprising silver, which may, among other things, be deposited by oxidation-reduction by bringing a solution of ammoniacal silver nitrate into contact with a reducing agent solution.

Then, the layer of decorative coating is applied over the silver layer to improve the chemical and mechanical resistance of the silver layer.

The decorative material is therefore supplied in a fluid state, insofar as it includes in particular one or more solvents.

The fluid decorative material is deposited directly onto an external face of the upper glass sheet 11a so as to form a layer of decorative coating and this layer of decorative coating is dried.

The application of the decorative layer on an external face of the already formed laminated glass is a mandatory step of the process according to the invention, despite its difficulty of implementation because it presents several advantages.

Firstly, it allows the appearance of a laminated glass panel manufactured beforehand, possibly on another production line, to be modified and the decorative coating to be chosen subsequently, possibly on a case-by-case basis.

Secondly, the superposition of at least two sheets of glass under the layer of decorative coating makes it possible to improve the optical quality of the coated laminated glass, particularly in the case where the aim is to form a laminated glass mirror.

In fact, each sheet of glass has flatness defects with a pitch of the order of a meter and optical defects with a pitch of the order of 1 cm to 10 cm, but which cannot all be found superimposed on each other when the two sheets of glass are assembled. The optical distortions of laminated glass coated on its external face are therefore less than if the coating had been inserted between the two sheets of glass.

To overcome the technical problem of obtaining a suitably crosslinked layer of decorative coating within an acceptable time for an industrial process (particularly for a continuous manufacturing process, in which the laminated glass panel to be coated is moved at constant speed on a production line), typically of the order of a few minutes or a few tens of minutes, the inventors have therefore considered using chemical hardeners or chemical catalysts.

In particular, it may be envisaged to incorporate into the decorative material in the fluid state a total proportion of one or more crosslinking catalysts and/or chemical hardeners P_cata equal to or greater than 0.1%, or even equal to or greater than 0.5% by mass, 1% by mass, 2% by mass of the decorative material in the fluid state, 2.5% by mass of the decorative material in the fluid state and optionally less than 10% by mass of the decorative material in the fluid state, or even less than 5% by mass of the decorative material in the fluid state.

According to one embodiment, a proportion of infrared radiation absorbers is also incorporated into the decorative material in the fluid state. Such absorbers have a high conversion rate of light at the wavelength to which they are dedicated into heat.

The protective varnish can be chosen, in a non-limiting manner, from: commercial anti-corrosion varnishes from suppliers such as FENZI (for example FENZI One coat LF 3 grey SG, FENZI one coat WBLF 6 varnishes), VALSPAR (for example references SKi420 or SK1440) or EUROCOATINGS (for example eurocoatings glasskin007 varnish).

In the case of a lacquer, it can be, without limitation, commercial lacquers from suppliers such as FENZI (for example, glassolux NG lacquer), MADER (for example, madercoat LRY168 and madercoat 572 lacquers) or VALSPAR (for example, reference SK3875).

As for the chemical hardener or crosslinking catalyst, it can be chosen according to the flowable decorative material.

In particular, an acid catalyst such as hydrofluoric acid, phosphoric acid, paratoluenesulfonic acid, or any other transesterification catalyst can be used.

The fluid decorative material in which at least one chemical hardener and/or at least one crosslinking catalyst has been incorporated is then deposited on the upper face 11a1 of the laminated glass panel to be coated so as to form at least one layer of decorative coating 13.

The deposition of the flowable decorative material can be carried out by means of a flowable material deposition device such as a curtain coater, a roller or a gun.

The thickness of at least one layer of decorative coating may be greater than 10 micrometers.

Then the layer of decorative coating is dried to achieve crosslinking and at least partial evaporation of the solvents.

The proportion P_cata of chemical hardener or crosslinking catalyst must be chosen to allow application of the decorative coating in a fluid state and in particular during an industrial process.

In particular, this proportion may be chosen to allow application of the decorative coating by means of a device such as a curtain machine.

In particular, it is not possible to increase the proportion of chemical hardener or crosslinking catalyst indiscriminately, since too high a proportion causes the product to set at too low a temperature and/or too quickly.

In such a case, the decorative material does not remain in a fluid state long enough to allow its application to the upper face 11a1 of the laminated glass panel to be coated.

Uncontrolled caking also leads to the obstruction of pipes or transport elements through which the decorative material must circulate.

The catalyst's solidification time was evaluated by observation with the naked eye in the case where the crosslinking catalyst is paratoluenesulfonic acid incorporated into the fluid decorative material is One Coat LF3 from the Fenzi brand in a proportion P_cata expressed as a percentage of the mass of the fluid decorative material.

The results are grouped in Table 1 below:

TABLE 1
Mass setting time as a function of the proportion
P_cata of crosslinking catalyst

| P_cata (%) | Solidification time (Qualitative h) |
|---|---|
| 0.1 | >24 |
| 0.5 | >24 |
| 1 | >24 |
| 2.5 | >24 |
| 5 | >24 |
| 10 | 9-24 |
| 25 | 2 |
| 50 | 0.5 |

It is found that an excessive proportion of chemical hardener or crosslinking catalyst leaves little time for further processing steps of the fluid decorative material, in particular for its application to the laminated glass panel to be coated.

It is therefore necessary to find a compromise between the proportion of chemical hardener or crosslinking catalyst, the drying temperature and the drying time.

A proportion P_cata of chemical hardener or crosslinking catalyst less than or equal to 10% by mass of the fluid decorative material, or even 5% by mass of the fluid decorative material, or even 2.5% by mass of the fluid decorative material may be suitable for implementing the method according to the first embodiment of the invention.

FIG. 2 schematically represents a drying device 112 comprising a furnace 101 for implementing an embodiment of the invention. The furnace 101 is a continuous furnace comprising an enclosure 102 and a heating system 103 adapted to place the interior of the enclosure 102 according to a given temperature profile. In particular, the heating system 103 is adapted to generate a given temperature profile in an area of the furnace in which the layer of decorative coating 13 is located. Typically, the heating system is regulated so that a set temperature in the area of the furnace where the polymer interlayer material is located is between 60° C. and 100° C., or even between 60° C. and 80° C. Determining this satisfactory temperature range at the level of the polymer interlayer material can be achieved in several ways. For example, a temperature measuring system is used within the furnace, capable of determining the temperature at the level of the polymer interlayer material. Alternatively, a temperature measuring system is used elsewhere in the furnace, and the temperature at the polymer interlayer material is determined by applying a predetermined rule relating the measured temperature to the temperature at the polymer interlayer material. This predetermined rule is, for example, determined during a preliminary calibration step. For example, the other place in the furnace where the temperature is measured is on the surface of the laminated glass panel. During the calibration stage, thermocouples are placed on the surface of the laminated glass panel before entering the furnace and, upon exiting the furnace, the condition of the layer of decorative coating and the polymer interlayer material is measured or checked to determine whether they are in satisfactory condition. If the polymer interlayer material is in a satisfactory condition, it means that it has not reached a temperature of 100° C. or even 80° C. If the layer of decorative coating is in a satisfactory condition, it means that it has been sufficiently heated, which implies that the nearby polymer interlayer material has been heated to at least 60° C. Depending on the result of this measurement or observation, and in view of the measurements from the sensors, the temperature of the heating devices is validated, lowered or increased until a satisfactory heating profile is obtained. We thus obtain a rule linking the temperature at the level of the polymer interlayer material with the measured temperature. During manufacturing, a panel is regularly instrumented to check whether the temperature measured at the thermocouples is similar to that corresponding to the calibration step and, if necessary, the temperature profile is adjusted.

According to one embodiment, the furnace is a continuous furnace comprising a conveyor system 104 suitable for moving a laminated glass panel from an inlet 105 to an outlet 106. The inlet 105 can be adapted to allow a laminated glass panel to enter the enclosure. The outlet 106 can be adapted to allow a laminated glass panel to protrude from the enclosure. The conveyor system 104 can be adapted to move the laminated glass panel continuously, in particular at a constant speed, between the inlet 105 and the outlet 106. Alternatively, the conveyor system 104 may not move the laminated glass panel at a constant speed, but for example move it according to a suitable movement profile, comprising for example one or more localized slowdowns, accelerations or stops. The laminated glass panel is arranged with its lower face 11b1 carried by the conveying device, and the layer of decorative coating 13 away from the conveying device.

The heating system 103 comprises, for example, one or more heating devices 107 adapted to provide convective and radiative heating.

The heating system 103 also includes one or more LASER heating devices 108. A LASER heating device 108 comprises an emitter 109 adapted to generate a LASER beam directed towards the layer of decorative coating 13. The laminated glass panel is thus placed with the layer of decorative coating 13 facing the LASER heating device 108. The LASER heating device 108 can thus be placed at the upper part of the enclosure, above the laminated glass panel. The LASER beam intercepts the laminated glass panel at a location that may be linear along a line transverse to the direction of movement of the panel in the furnace. The energy of the beam is then transformed into heat in the coating layer. Linear location can be achieved by scanning a point LASER beam along a cross line at a predetermined speed. The LASER heating device 108 thus allows localized heating of the layer of decorative coating 13 which complements the heating generated by the heating devices 107. Substantial energy savings are achieved because the heating is provided locally where it is needed, and not to the entire volume of the laminated glass panel. In addition, the energy required for subsequent cooling of the laminated glass panel is also reduced. The wavelength of the emitted beam can, for example, be chosen so that it is absorbed by the coating layer. It can be located mainly in the near infrared, more particularly between 800 and 1100 nanometers (nm), for example between 800 and 1000 nanometers (nm). Moreover, the glass panel is transparent to such radiation, so that the heat transfer towards the glass panel, and consequently to the interlayer material, is reduced.

According to one embodiment, the emitter 109 is a continuous transmitter. It has an average maximum power of less than 500 Watts (W). According to one embodiment, the emitter 109 of the LASER heating device emits a LASER beam with a power of less than 100 Watts (W). This power range can achieve the desired heating effect, without burning, for limited energy consumption. According to one embodiment, the emitter 109 of the LASER heating device emits a LASER beam at a power of less than 50 W, less than 40 W, less than 35 W, or even less than 30 W. According to the embodiments, and if compatible with the embodiments presented above, the emitter 109 emits a LASER beam at a power greater than 25 W, greater than 30 W, greater than 35 W, or even greater than 40 W.

According to one embodiment, the LASER heating device 108 is configured to have an inter-line gap of between 10 microns and 100 microns. This range of inter-line gaps can provide heat in a sufficiently homogeneous manner at the level of the layer of decorative coating 13. Depending on the embodiments, the inter-line gap is between 25 and 85 microns, or even between 35 and 75 microns.

According to one embodiment, the LASER heating device 108 is configured to have a defocusing at the level of the layer of decorative coating 13 of between 5 millimeters (mm) and 100 mm, in particular between 5 mm and 50 mm. Defocus corresponds to the diameter of the focal spot at the level of the layer of decorative coating 13. This defocusing range allows the heat to be distributed sufficiently evenly at the level of the layer of decorative coating 13. Depending on the embodiments, the defocusing range is between 5 mm and 70 mm, or even between 10 mm and 40 mm, or even between 15 mm and 30 mm.

According to one embodiment, the LASER heating device 108 is configured to move the LASER beam at the layer of decorative coating 13 at a speed, in the transverse direction, of between 0.2 meters per second (m/s) and 10 m/s. This speed range allows the heat to be distributed sufficiently evenly across the layer of decorative coating 13. Depending on the embodiments, the speed range is between 1 m/s and 5 m/s, or even between 2 m/s and 3 m/s.

According to one embodiment, the LASER heating device 108 is configured to generate a number of passages of the LASER beam at each point of the layer of decorative coating 13 between 1 and 200. This range of passage numbers allows the local temperature level to be maintained above a threshold value for a time greater than a predetermined threshold duration. Depending on the embodiments, the number of passages is between 2 and 50, between 5 and 20, or even between 10 and 15.

According to yet another embodiment, the LASER heating device 108 comprises a plurality of LASER diodes, each LASER diode illuminating a respective portion of the coated laminated glass panel 1 opposite the LASER diode (each light beam being, where appropriate, guided by a respective optical fiber). The plurality of LASER diodes are arranged so as to generate as uniform an illumination as possible of the underlying plane in which the layer of decorative coating 13 is arranged. For example, between 100 and 2000 LASER diodes are used. Following a series of tests, it is identified that the heating system 103 can be configured to generate, at the level of the layer of decorative coating 13, a surface energy of between 400 and 1500 kiloJoules per square meter (kJ/m²) of panel. This range makes it possible to exceed, at the level of the layer of decorative coating 13, an average temperature threshold allowing the crosslinking of the layer of decorative coating 13, without any burning effect and without any undesirable effect on the underlying layer of polymer interlayer material. According to the embodiments, the heating system 103 is configured to generate, at the level of the layer of decorative coating 13, a surface energy of between 450 and 850 kJ/m², between 500 and 800 kJ/m², between 550 and 750 kJ/m², or even between 600 and 700 kJ/m².

The setting of the LASER heating device may depend in particular on the characteristics of the decorative coating. For example, in the case where the decorative coating includes a reflective layer, for example a silver layer, it may be necessary to provide a higher surface energy, for example between 850 and 1500 kJ/m², even if an opaque layer is placed between this silver layer and the coating layer to be polymerized. Alternatively or additionally, if the decorative coating comprises several layers of a distinct nature, the thermal characteristics of the layers may differ, which may have an effect on the setting of the LASER heating device.

The parameters of the installation, in particular the linear speed of movement of the panel in the furnace, the power of the heating devices 107, the average power of the emitter 109, the interline spacing, the defocusing, the speed of movement of the LASER beam in the transverse direction, the number of passes, as presented above, can be adjusted, in the ranges presented above, to obtain this surface energy.

The location of interception of the LASER beam with the layer of decorative coating 13 is for example offset from the inlet 105 by at least one tenth of the length of the furnace, in particular by at least one fifth of the length of the furnace. Thus, the furnace is designed to have a first zone 110, close to the inlet 105, in which both convective heating and radiative heating are implemented to promote the evaporation of the solvents from the layer of decorative coating 13, and a second zone 111, downstream, for drying the layer of decorative coating 13. The location of interception of the LASER beam with the layer of decorative coating 13 is located in the second zone 111, in particular in an upstream zone of this second zone 111. The emitter 109 is for example arranged vertically above this interception location, so as to minimize the optical path of the LASER beam. Alternatively, a second heating device 107 is not provided downstream of the LASER heating device 108.

In the case of a continuous furnace, the above-mentioned set temperature range is determined in a longitudinally central section of the furnace. Indeed, in a furnace entry area, if the laminated glass panels come from outside the furnace at room temperature, the initial temperature of the polymer interlayer material may also be at room temperature.

In a particular embodiment, the P_cata ratio is chosen in the range [0.1%-5%], more particularly in the range [0.5%-2.5%] or more particularly [0.75%-1.25%]. In a particular embodiment, the P cata ratio is equal to 1%. For each of the four options for choosing the proportion P cata above, the set temperature in the furnace enclosure T ext can be chosen:
in the range [120° C.; 140° C.], the duration t_chauff then being less than or equal to 7.5 minutes and optionally greater than 3 minutes,
in the range [100° C.; 120° C.], the duration t_chauff then being greater than or equal to 7.5 minutes; in particular if the upper glass sheet 11a is made of clear glass and has a thickness of between 2 mm and 6 mm, and if the layer of decorative coating has a thickness before drying of between 50 μm and 20 μm.

In a particular embodiment, the at least one layer of decorative coating 13 consists of one or more layers of lacquer.

In another embodiment, the decorative coating comprises at least one layer of reflective material, so as to form a mirror.

The thickness of the reflective material layer can be adapted to obtain a surface mass of silver greater than the standard of 700 mg/m².

Since the reflective material is subject to oxidation and has low mechanical resistance, a layer of protective varnish can be applied to the layer of reflective material.

According to another embodiment, the heating system 103 does not include heating devices 107. In this case, heating is carried out exclusively by the LASER heating device108. The LASER heating device 108 can then comprise several emitters 109 arranged along the path of the laminated glass panel and generating separate LASER beams intercepting the laminated glass panel along its path.

A laminated glass panel is thus obtained comprising at least two sheets of glass and in which at least two successive sheets of glass are assembled by means of a polymer interlayer material, the laminated glass panel having an upper face 11a1 and a lower face 11b1, and the upper face of the laminated glass panel 11a1 is coated with at least one layer of decorative coating 13 formed from a fluid decorative material and the polymer interlayer material of which does not have any bubbling defect observable to the naked eye. In one embodiment of the coated laminated glass panel, the interlayer polymer material is tinted. In the case where the laminated glass panel is coated with a reflective material so as to form a mirror, this arrangement makes it possible in particular to obtain a tinted mirror, for example bronze in color, without having to resort to the usual processes for tinting mirrors, a process which is heavy and costly to implement.

In one embodiment of the coated laminated glass panel, heating means are incorporated either into the polymeric interlayer material or into at least one of the two glass sheets. For example, heating micro-fabrics can be incorporated into PVB, or one of the two glass sheets or the glass panel can be of the EGLAS® type from Saint Gobain®. This arrangement makes it possible to obtain a heated coated glass panel, such as a heated mirror, whose mechanical resistance is improved compared to the solutions of the prior art.

The invention finally relates to the use of a laminated glass panel:
in the construction sector, in particular for the creation of decorative partition walls or floors meeting the required safety standards,
or in the field of furniture for the production of furniture including walls or decorative wall elements meeting the required safety standards, for example custom-made furniture.

### Example 1

A furnace 101 as presented above, equipped with a conveying system at a longitudinal speed of 5 meters per minute (m/min) comprises a LASER heating device 108 emitting a LASER beam of wavelength 1070 nanometers (nm) as the only heating system. The LASER heating device is configured as follows:
Power: 40 W,
Beam movement speed: 1.5 m/s,
Line spacing: 20 μm,
Defocus: 5 mm,
Number of passages: 80.

A test of the resistance of the coating layer of the coated laminated glass panel is carried out following heat treatment. The test consists of rubbing an optical paper soaked in acetone along a predetermined trajectory on the coating layer, and visually checking the presence of the coating layer on the optical paper at the end. For products manufactured according to the example above, the optical inspection does not reveal any presence of a coating layer on the optical paper, allowing us to conclude that the coating layer is holding up well on its substrate.

### Example 2

A furnace 101 as presented above, equipped with a conveying system at a longitudinal speed of 5 meters per minute (m/min) comprises a heating device 107 and a LASER heating device 108 comprising a network of 200 continuous LASER diodes of 100 W each, each emitting a LASER beam of wavelength 976 nanometers (nm), and arranged in a matrix, and a set of optical fibers respectively guiding the LASER beam to a respective location in the furnace. The diameter of the focal spot at the level of the coating layer is 60 millimeters, obtained by divergence of the optical beam at the fiber output.

A test of the resistance of the coating layer of the coated laminated glass panel is carried out following heat treatment. The test consists of rubbing an optical paper soaked in acetone along a predetermined trajectory on the coating layer, and visually checking the presence of the coating layer on the optical paper at the end. For products manufactured according to the example above, the optical inspection does not reveal any presence of a coating layer on the optical paper, allowing us to conclude that the coating layer is holding up well on its substrate.

### LIST OF REFERENCE SIGNS

1: coated laminated glass panel
11a: upper glass sheet
11a1: upper face of the laminated glass panel to be coated
11b: lower glass sheet
11b1: lower face of the laminated glass panel to be coated
12: interlayer of polymer material
13: layer of decorative coating
101: furnace
102: enclosure
103: heating system
104: conveyor system
105: inlet
106: outlet
107: heating device
108: LASER heating device
109: Emitter
110: First zone
111: second zone
112: drying device

1. A method of manufacturing a coated laminated glass panel, wherein the method comprises:
a laminated glass panel to be coated is provided comprising at least two sheets of glass and at least two successive sheets of glass are assembled by means of a polymer interlayer material forming after assembly an interlayer the laminated glass panel to be coated having at least one upper face to be coated;
a flowing decorative material is provided;
at least one layer of decorative coating is formed by applying the decorative material in the fluid state to the upper face of the laminated glass panel to be coated;
the layer of decorative coating is dried by heating the laminated glass panel thus covered using a drying device,
the drying device has a set temperature at the level of the polymer interlayer material greater than or equal to 60° C. and less than 100° C., and the drying device comprises at least one LASER heating device adapted to emit a beam in the direction of the layer of decorative coating.

2. The method of manufacturing a coated laminated glass panel according to claim 1 wherein the polymeric interlayer material is selected from polyvinyl butyral, ethylene vinyl acetate, an ionoplast polymer, thermoplastic polyurethane and a casting resin.

3. The method of manufacturing a coated laminated glass panel according to claim 1, wherein the at least one layer of decorative coating consists of either:
a layer of reflective material and one or more layers of protective varnish;
or one or more layers of lacquer and optionally one or more layers of protective varnish.

4. The method for manufacturing a coated laminated glass panel according to claim 1 in which a chemical hardener or a crosslinking catalyst is incorporated into the fluid decorative material with a ratio P_cata between the mass of chemical hardener or crosslinking catalyst and the mass of decorative material in the fluid state, and in which the ratio P_cata of the mass of chemical hardener or crosslinking catalyst with respect to the mass of decorative material in the fluid state is greater than 0.1%.

5. The method of manufacturing a coated laminated glass panel according to claim 4, wherein the chemical hardener or crosslinking catalyst is chosen from acid catalysts.

6. The method of manufacturing a coated laminated glass panel according to claim 1, wherein the drying device further comprises at least one heating device adapted to carry out convective and radiative heating.

7. The method of manufacturing a coated laminated glass panel according to claim 1, wherein a conveyor system moves the coated laminated glass panel in the drying device between an inlet and an outlet, the inlet and the outlet defining a length of the furnace, and wherein the LASER heating device is adapted to emit the beam towards a beam interception location with the layer of decorative coating, wherein the beam interception location is offset from the inlet by at least one tenth of the length of the furnace.

8. The method of manufacturing a coated laminated glass panel according to claim 6, wherein a conveyor system moves the coated laminated glass panel in the drying device between an inlet and an outlet, the inlet and the outlet defining a length of the furnace, and wherein the LASER heating device is adapted to emit the beam towards a beam interception location with the layer of decorative coating, wherein the beam interception location is offset from the inlet by at least one tenth of the length of the furnace, and wherein said heating device adapted to carry out convective and radiative heating is arranged upstream of the LASER heating device.

9. The method of manufacturing a coated laminated glass panel according to claim 1, wherein said set temperature is less than 80° C.

10. The method for manufacturing a coated laminated glass panel according to claim 1, wherein:
the heating system is configured to generate at the layer of decorative coating (103) a surface energy of between 400 and 1500 kJ/m² of panel, in particular between 450 and 850 kJ/m², 500 and 800 kJ/m², between 550 and 750 kJ/m², or even between 600 and 700 kJ/m².

11. The manufacturing method according to claim 1, in which a laminated glass panel to be coated is provided comprising at least one layer of silver having said upper face to be coated.

12. The manufacturing method according to claim 1, wherein said LASER heating device is adapted to emit said beam in the near infrared towards the layer of decorative coating.

13. A system for manufacturing a coated laminated glass panel, wherein the system comprises:
a laminated glass panel to be coated comprising at least two sheets of glass and in which at least two successive sheets of glass are assembled by means of a polymer interlayer material forming after assembly an interlayer, the laminated glass panel to be coated having at least one upper face to be coated;
a fluid decorative material;
an application device adapted to apply decorative material in the fluid state on the upper face of the laminated glass panel to be coated to format least one layer of decorative coating;
a drying device adapted to dry the layer of decorative coating by heating the laminated glass panel thus covered with a set temperature at the level of the polymer interlayer material greater than or equal to 60° C. and less than 100° C., the drying device comprising at least one LASER heating device adapted to emit a beam towards the layer of decorative coating.

14. The system for manufacturing a coated laminated glass panel according to claim 13, further comprising at least one of the following features:
the heating system is configured to generate at the layer of decorative coating a surface energy of between 400 and 1500 kJ/m² of panel, in particular between 450 and 850 kJ/m² in particular between 500 and 800 kJ/m², between 550 and 750 kJ/m², or even between 600 and 700 kJ/m²;
an emitter of the LASER heating device is adapted to emit a LASER beam with a power of less than 100 W, in particular less than 50 W, less than 40 W, less than 35 W, or even less than 30 W;
the LASER heating device is configured to have an inter-line gap of between 10 microns and 100 microns, in particular between 25 and 85 microns, or even between 35 and 75 microns;
the LASER heating device is configured to have a defocusing at the level of the layer of decorative coating of between 5 mm and 50 mm, in particular between 10 mm and 40 mm, or even between 15 mm and 30 mm;
the LASER heating device is configured to move the LASER beam at the layer of decorative coating at a speed of between 0.2 m/s and 10 m/s, in particular between 1 m/s and 5 m/s, or even between 2 m/s and 3 m/s;
the LASER heating device is configured to generate a number of passages of the LASER beam at each point of the layer of decorative coating between 1 and 200, in particular between 2 and 50, between 5 and 20, or even between 10 and 15;
the LASER heating device comprises a plurality of LASER diodes, in particular between 100 and 2000 LASER diodes.

15. The system for manufacturing a coated laminated glass panel according to claim 13, wherein said LASER heating device is adapted to emit said beam in the near infrared towards the layer of decorative coating.

16. The method of manufacturing a coated laminated glass panel according to claim 5, wherein the chemical hardener or crosslinking catalyst is chosen from hydrofluoric acid, phosphoric acid and paratoluenesulfonic acid.

17. The method of manufacturing a coated laminated glass panel according to claim 7, wherein the beam interception location is offset from the inlet by at least one fifth of the length of the furnace.

18. The method for manufacturing a coated laminated glass panel according to claim 1, wherein an emitter of the LASER heating device emits a LASER beam at a power of less than 100 W, in particular less than 50 W, less than 40 W, less than 35 W, or even less than 30 W.

19. The method for manufacturing a coated laminated glass panel according to claim 1, wherein the LASER heating device is configured to have an inter-line gap of between 10 microns and 100 microns, in particular between 25 and 85 microns, or even between 35 and 75 microns.

20. The method for manufacturing a coated laminated glass panel according to claim 1, wherein the LASER heating device is configured to have a defocusing at the level of the layer of decorative coating of between 5 mm and 50 mm, in particular between 10 mm and 40 mm, or even between 15 mm and 30 mm.

21. The method for manufacturing a coated laminated glass panel according to claim 1, wherein the LASER heating device is configured to move the LASER beam at the layer of decorative coating at a speed of between 0.2 m/s and 10 m/s, in particular between 1 m/s and 5 m/s, or even between 2 m/s and 3 m/s.

22. The method for manufacturing a coated laminated glass panel according to claim 1, wherein the LASER heating device is configured to generate a number of passages of the LASER beam at each point of the layer of decorative coating between 1 and 200, in particular between 2 and 50, between 5 and 20, or even between 10 and 15.

23. The method for manufacturing a coated laminated glass panel according to claim 1, wherein the LASER heating device comprises a plurality of LASER diodes, in particular between 100 and 2000 LASER diodes.
